(19) United States
(12) Patent Application Publication
(10) Pub. No.: US 2019/0315120 A1
(43) Pub. Date: Oct. 17, 2019

(54) LIQUID DISCHARGE HEAD AND LIQUID DISCHARGE APPARATUS

(71) Applicant: TOSHIBA TEC KABUSHIKI KAISHA, Tokyo (JP)

(72) Inventors: Tomomi IIJIMA, Mishima Shizuoka (JP); Hiroyuki KUSHIDA, Odawara Kanagawa (JP); Naoaki KIRYU, Mishima Shizuoka (JP)

(21) Appl. No.: 16/351,952

(22) Filed: Mar. 13, 2019

(30) Foreign Application Priority Data
Apr. 13, 2018 (JP) 2018-077823

(51) Int. Cl. B41J 2/045; B41J 2/14

(52) U.S. Cl. CPC B41J 2/04541; B41J 2/14; B41J 2/04586

(57) ABSTRACT

A liquid discharge head includes a head, a liquid supply conduit, a liquid discharge conduit, a radiator, first and second wiring boards, and a heat conductive member. Liquid is supplied to the head through the liquid supply conduit. Liquid that passed the head flows through the liquid discharge conduit. The radiator includes a flow path through which liquid from the liquid discharge conduit flows. The first wiring board is between the head and the radiator, and has a connector connected to a wiring extending through an interior of the radiator. The second wiring board is disposed between the head main body and the first wiring board, and includes, thereon, a driving control element configured to control liquid discharge from the discharge holes. The heat conductive member extends between the head and the radiator, and is in thermal contact with the radiator.

### CROSS-REFERENCE TO RELATED APPLICATION

This application is based upon and claims the benefit of priority from Japanese Patent Application No. 2018-077823, filed on Apr. 13, 2018, the entire contents of which are incorporated herein by reference.

### FIELD

Embodiments described herein relate generally to a liquid discharge head and a liquid discharge apparatus.

### BACKGROUND

An inkjet head used for a printer, or other liquid discharge apparatus, includes a head including a piezoelectric element for discharging ink and a driving control integrated circuit (IC) for driving the piezoelectric element. A substrate on which the driving control IC is mounted, or a substrate on which an electronic component is mounted, is generally accommodated within an inner cover to prevent adhesion of ink or foreign matters.

The inner cover functions as a heat sink and heat generated from the driving control IC is emitted to the outside via the inner cover. Thus, as the inner cover becomes larger, the heat dissipation effect, with respect to the heat generated from the driving control IC, increases. However, in recent years, the load of the driving control IC has been increasing due to increases in printing rate and printing speed, and this leads to an increase in the amount of heat generation. Considering the size of the entire apparatus, it is no longer possible to just enlarge the inner cover to promote heat dissipation.

### DESCRIPTION OF THE DRAWINGS

FIG. 1 illustrates a perspective view of an inkjet head according to a first embodiment.

FIG. 2 illustrates a front view of the inkjet head.

FIG. 3 illustrates a cross-sectional view of the inkjet head taken along a line III-III of FIG. 2 and viewed in arrow direction.

FIG. 4 illustrates an exploded perspective view of a cooling unit in the inkjet head.

FIG. 5 illustrates a cross-sectional view of a main portion of the inkjet head.

FIGS. 6-10 each illustrate a perspective view of the inkjet head to illustrate an assembly process of the inkjet head.

FIG. 11 illustrates a front view of an inkjet head according to a second embodiment.

FIG. 12 illustrates a cross-sectional view taken along a line VII-VII of FIG. 11 and viewed in arrow direction.

FIG. 13 illustrates an exploded perspective view of a cooling mechanism of the inkjet head.

FIG. 14 is a diagram illustrating a printer including an inkjet head according to an embodiment.

### DETAILED DESCRIPTION

Embodiments provide a liquid discharge head and a liquid discharge apparatus with improved cooling efficiency and stabilized temperature even if an amount of heat generation of a driving control integrated circuit (IC) increases.

In general, according to an embodiment, a liquid discharge head includes a head, a liquid supply conduit, a liquid discharge conduit, a radiator, a first wiring board, a second wiring board, and a heat conductive member. The head includes a plurality of discharge holes. Liquid is supplied to the head through the liquid supply conduit. Liquid that passed the head flows through the liquid discharge conduit. The radiator is disposed apart from the head and includes a flow path through which liquid from the liquid discharge conduit flows. The first wiring board is disposed between the head and the radiator, and has a connector connected to a wiring extending through an inner space of the radiator. The second wiring board is disposed between the head main body and the first wiring board, and includes, thereon, a driving control element configured to control liquid discharge from the discharge holes. The heat conductive member extends between the head and the radiator, and is thermally in contact with the radiator.

Hereinafter, exemplary embodiments will be described with reference to accompanying drawings. In drawings, same reference numerals denote same elements. For the purpose of description, the scale and relative dimensions of aspect depicted in the drawings may vary from actual devices.

### First Embodiment

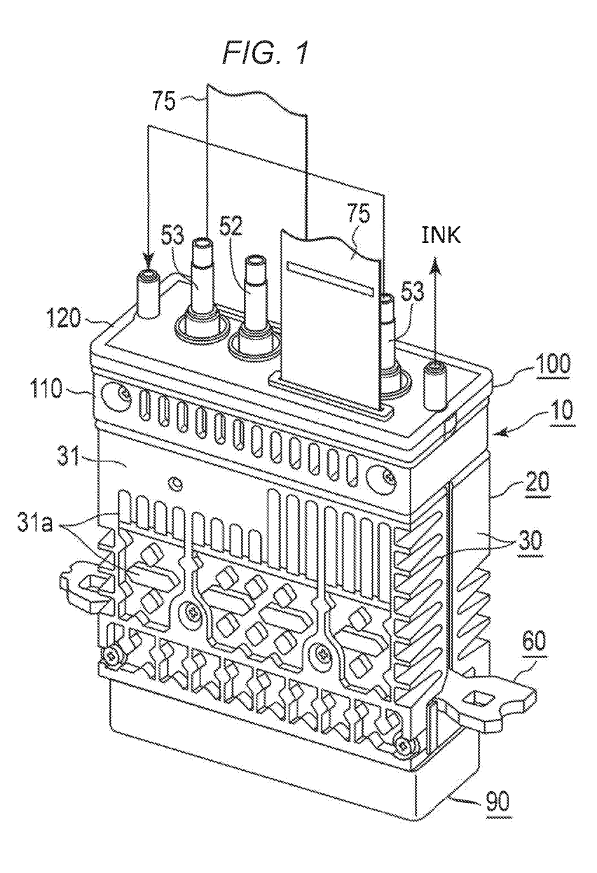

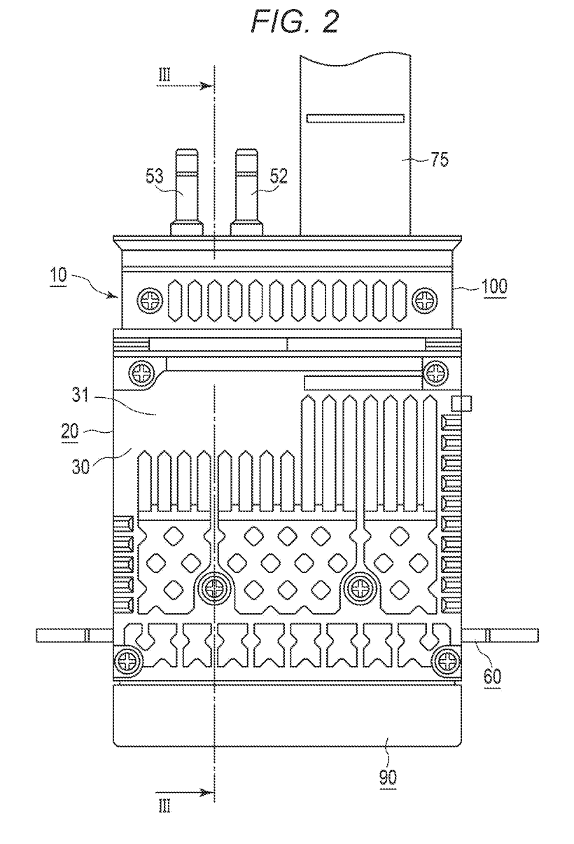

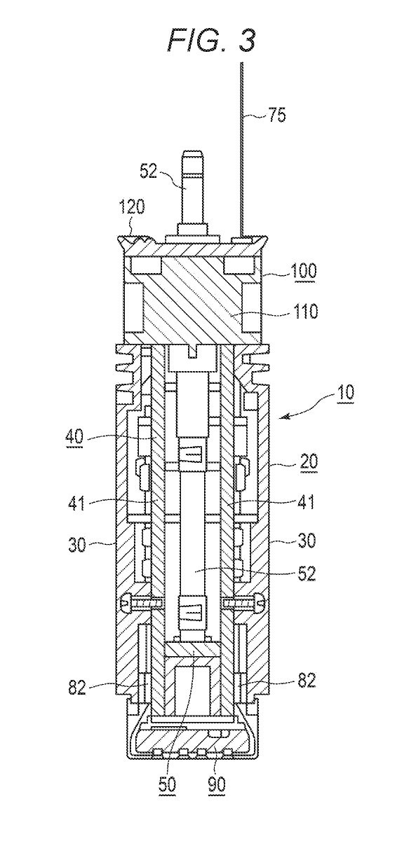

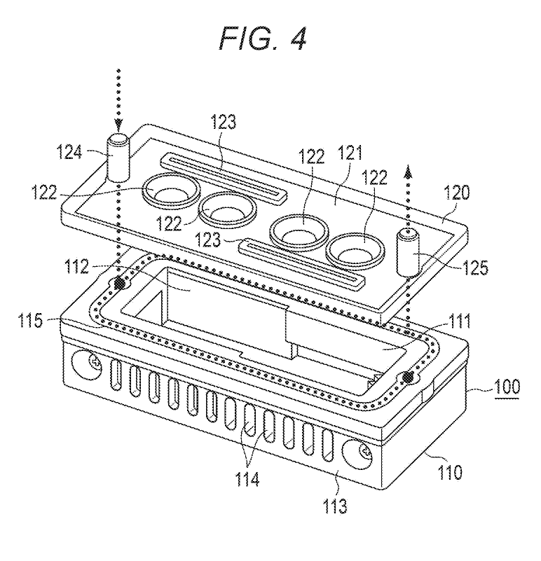

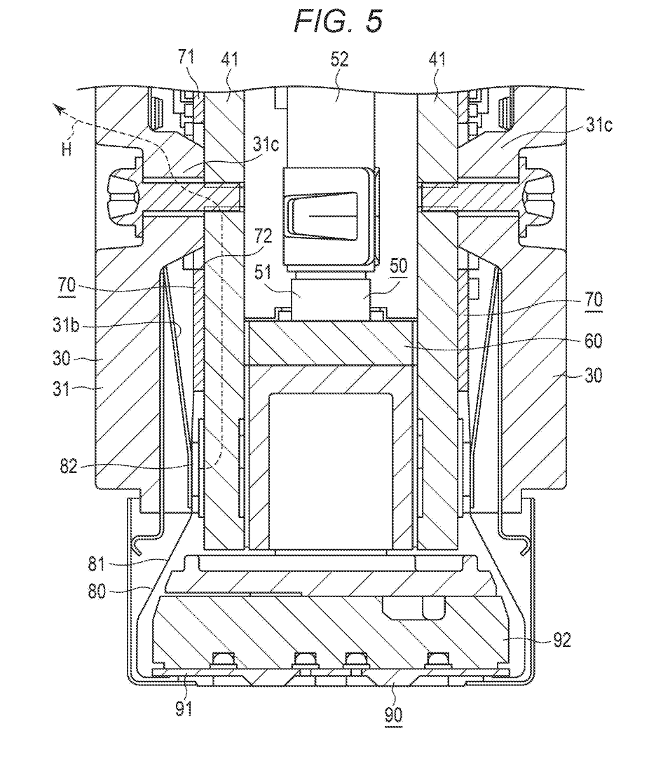

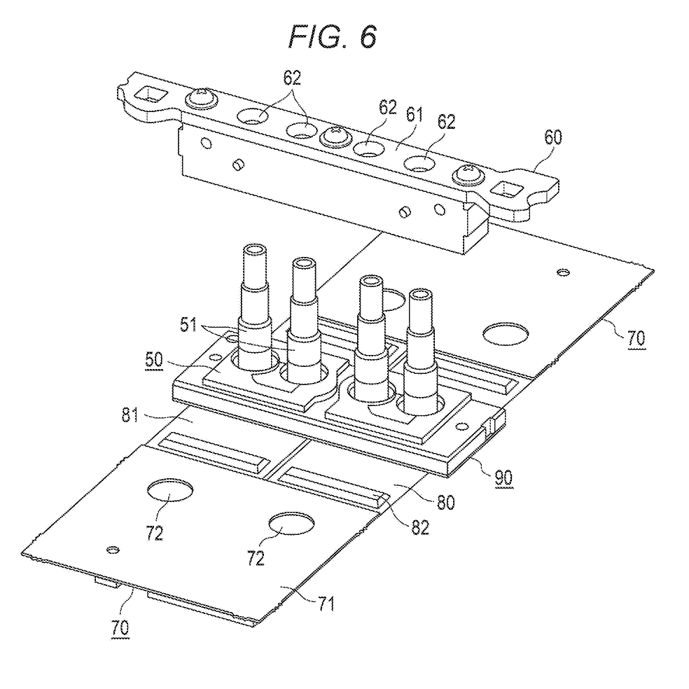

Hereinafter, a printer 1, which may also be referred to as a liquid discharge apparatus 1, and an inkjet head 10, which may also be referred to as a liquid discharge head 10, according to an embodiment will be described. FIG. 1 illustrates a perspective view of the inkjet head 10. FIG. 2 illustrates a front view of the inkjet head 10. FIG. 3 illustrates a cross-sectional view of the inkjet head 10 taken along a line III-III of FIG. 2 and viewed in arrow direction. FIG. 4 illustrates an exploded perspective view of a cooling unit 100, which may also be referred to as a radiator 100, in the inkjet head 10. FIG. 5 illustrates a cross-sectional view of a main portion of the inkjet head 10. FIGS. 6-10 each illustrate a perspective view of the inkjet head 10 to illustrate an assembly process of the inkjet head 100.

As illustrated in FIG. 1, the inkjet head 10 is connected to an ink duct 5.

The inkjet head 10 includes a head main body 20 and the cooling unit 100 disposed above the head main body 20. The head main body 20 includes a pair of side covers 30. Each side cover 30 is formed, of, for example, an aluminum material having relatively high thermal conductivity.

A driving unit 40 is accommodated in the head main body 20 between the side covers 30. The side cover 30 includes a main plate 31 and a pair of side plates 32 integrally formed on both sides of the main plate 31. The main plate 31 and the side plates 32 include radiation fins 31a and 32a. The main plate 31 and the side plates 32 function as a heat sink. A leaf spring 31b biased inward and a protruding portion 31c are formed on an inner surface of the main plate 31. Instead of the leaf spring 31b, another elastic body, such as silicon rubber, may be used.

The driving unit 40 includes a pair of inner plates 41, which may be referred to as heat conductive members 41. An ink circulating unit 50 and a reference plate 60 are disposed between the inner plates 41. The inner plate 41 and the reference plate 60 are fixed by screws.

The ink circulating unit 50 includes four cylindrical connecting portions 51. The connecting portions 51 are connected to an ink supply tube 52 and an ink discharge tube. The other end of the ink supply tube 52 is connected to an ink circulation mechanism 15. The other end of the ink discharge tube 53 is connected to a cooling ink inlet port 124 described below.

The reference plate 60 is a member for fixing and positioning the inkjet head 10 to attach the inkjet head 10 to a printer main body. The reference plate 60 includes a plate 61. The plate 61 includes four opening holes 62. An outer periphery of the connecting portion 51 described above is fitted in the opening hole 62, and bonded and fixed.

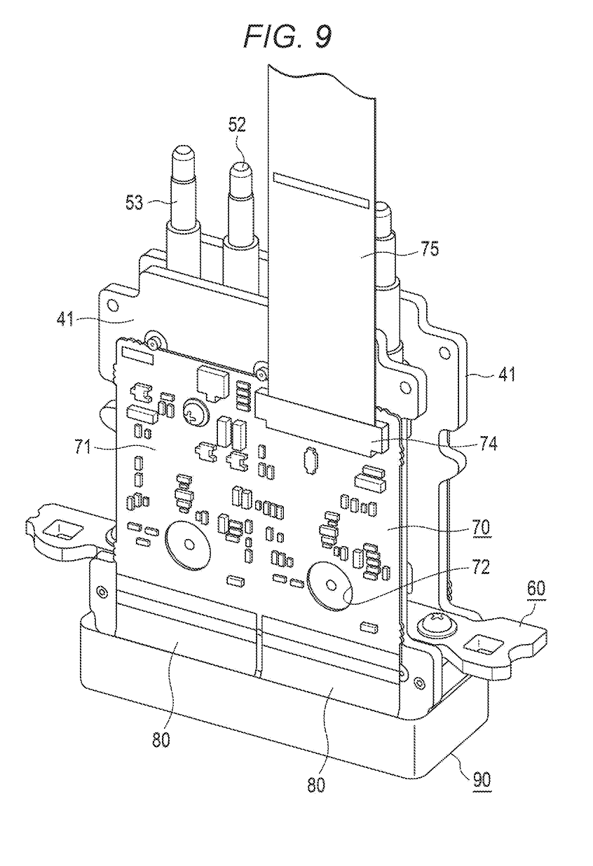

A printed wiring board 70, which may be referred to as a first substrate 70, includes a substrate body 71. A hole portion 72 is formed on the substrate body 71. The hole portion 72 is formed above a driving control integrated circuit (IC) 82. An insulating film 73 is attached to an outer surface of the substrate body 71. The substrate body 71 is fixed to the inner plate 41 via the insulating film 73. The insulating film 73 is, for example, a graphite sheet. A control element is mounted on the substrate body 71. A communication terminal 74 illustrated in FIG. 9 is used for communication with a control unit 2, and a flat cable 75 is connected to the communication terminal 74.

As illustrated in FIG. 5, a wiring film 80, which may also be referred to as a second substrate 80, is disposed below the printed wiring board 70. The wiring film 80 includes a flexible film base 81. Wires connected to signal lines are provided on the film base 81. The driving control IC 82, which may also be referred to as a driving control element 82, is mounted inside the film base 81. A surface of the driving control IC 82 opposite to the wiring film 80 is connected to the inner plate 41 with the insulating film 73 therebetween.

The printed wiring board 70 is connected to an upper end of the wiring film 80, and a head plate 91 is connected to a lower end.

A discharge unit 90 is provided at a lower portion of the head main body 20. The head plate 91, which may also be referred to as a head main body 91, is disposed at a lowermost end of the discharge unit 90. A discharge hole for discharging ink and a pressure chamber are formed in the head plate 91. Wiring of the wiring film 80 driving the pressure chamber is connected to each pressure chamber.

The driving control IC 82 is pressed from the main plate 31 towards the inner plate 41 by an elastic body (such as, without limitation, a leaf spring, a silicon rubber, or the like) into contact the inner plate 41, and heat generated by the driving control IC 82 is transmitted to the inner plate 41. The leaf spring 31b abuts on the vicinity of the driving control IC 82, and thus the heat is also transmitted to the main plate 31 via the leaf spring 31b.

The head plate 91 is in contact with a manifold 92 on a top surface. The manifold 92 includes a flow path communicating with the pressure chamber to supply and discharge ink. A connecting portion to which an ink supply tube and an ink discharge tube are connected is adhered to the manifold 92.

The cooling unit 100 includes a housing 110 having a rectangular frame shape, and a top cover 120 covering an upper surface side. Both the housing 110 and the top cover 120 are preferably formed of a material having high thermal conductivity, such as aluminum, magnesium, or ceramic.

A recessed portion 112 is formed on an inner wall surface 111 of the housing 110. An upper end portion of the inner plate 41 described above is in contact with the inner wall surface 111. The flat cable 75 is positioned in the recessed portion 112. Cooling fins 114 are formed on an outer wall surface 113 of the housing 110. A flow path 115, which may also be referred to as a groove 115, through which ink flows is formed inside the housing 110. The flow path 115 is covered with a plate 121.

The top cover 120 includes the plate 121. The plate 121 includes holes 122 through which two sets of ink supply tubes 52 and ink discharge tubes 53 pass. A slit-shaped hole 123 through which the flat cable 75 passes is formed. The cooling ink inlet port 124 and a cooling ink outlet port 125 are formed and connected to the flow path 115. The cooling ink inlet port 124 is connected to the other end of the ink discharge tube 53, and the other end of the cooling ink outlet port 125 is connected to an ink circulation mechanism 4. Ink supplied from the cooling ink inlet port 124 passes through the flow path 115 and is discharged from the cooling ink outlet port 125.

The inkjet head 10 is assembled as follows. As illustrated in FIG. 6, the wiring film 80 is mounted on the head plate 91. The printed wiring board 70 is connected to the wiring film 80. The manifold 92 is attached to the head plate 91. The connecting portion 51 is attached to the manifold 92. The connecting portion 51 is passed through the opening hole 62 of the reference plate 60.

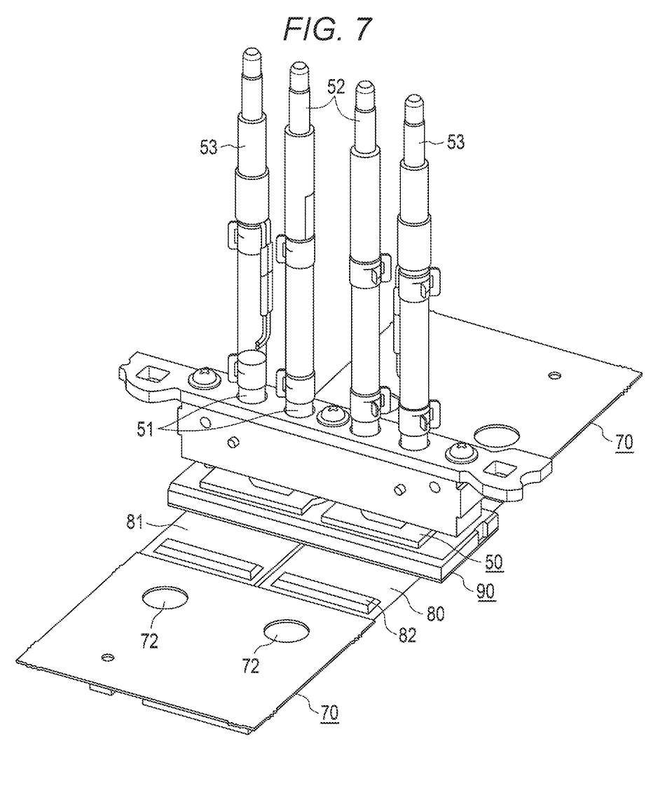

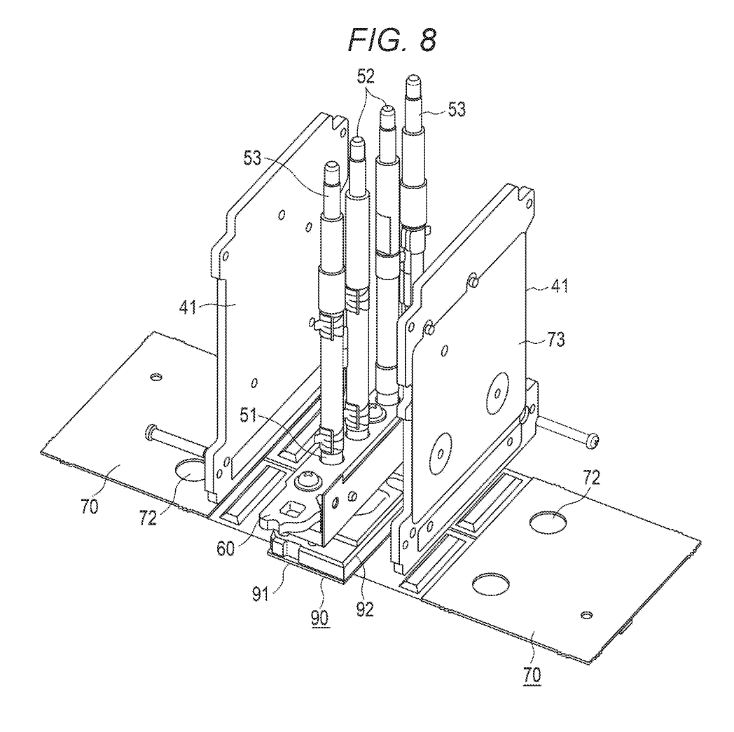

Then, as illustrated in FIG. 7, the ink supply tube and the ink discharge tube 53 are attached to the connecting portion 51. Next, as illustrated in FIG. 8, the inner plate 41 is fixed to the reference plate 60. Then, as illustrated in FIG. 9, the printed wiring board 70 is attached to the inner plate 41. The flat cable 75 is connected to the communication terminal 74 of the printed wiring board 70.

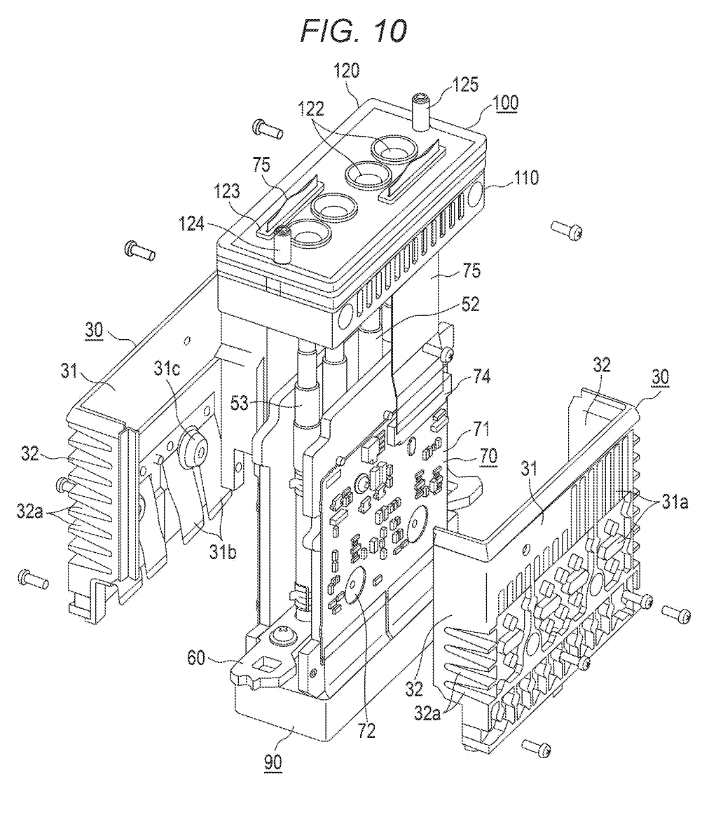

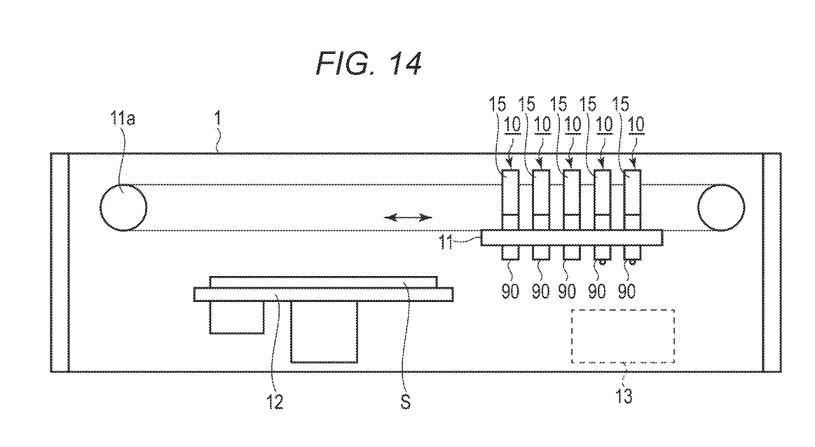

Then, as illustrated in FIG. 10, the inner plate 41, the ink supply tube 52, the ink discharge tube 53, and the flat cable 75 are passed through the inner wall surface 111 side of the cooling unit 100. The side covers 30 are combined. Here, the protruding portion 31c of the side cover 30 is fitted to the inner plate 41 from the hole portion 72 and then screwed. The leaf spring 31b presses the driving control IC 82 towards the inner plate 41. The ink supply tube 52 is connected to the ink circulation mechanism 4. The ink discharge tube 53 is connected to the cooling ink inlet port 124. The other end of the cooling ink outlet port 125 is connected to the ink circulation mechanism 15 (see FIG. 14).

The inkjet head 10 assembled as such is subjected to printing and cooling as follows. In other words, when a print command is input from the outside, the driving control IC 82 starts to control the pressure chamber of the head plate 91, and discharges ink supplied from the ink supply tube 52 towards a recording medium S (see FIG. 14). Here, the driving control IC 82 generates heat. The heat of the driving control IC 82 is transferred to the inner plate 41 in direct contact with the driving control IC 82. The heat transferred to the inner plate 41 is diffused upward as indicated by a broken line H in FIG. 5. The inner plate 41 contacts the protruding portion 31c of the side cover 30, and heat is transferred to the side covers 30. Since the inner plate 41 and the side covers 30 are in contact at the shortest distance by the hole portion 72, a heat transfer efficiency may be enhanced. When the leaf spring 31b is used as an elastic body, heat is also transferred to the main plate 31 via the leaf spring 31b, and thus the heat transfer efficiency is enhanced.

Meanwhile, an upper end of the inner plate 41 is connected to the cooling unit 100. In the cooling unit 100, ink that passed through the discharge unit 90 is introduced via the ink discharge tube 53 to cool the inner plate 41. A temperature of the ink flowing through the ink discharge tube 53 is detected by a temperature sensor, and a flow rate of the ink is adjusted to maintain the temperature in a certain range or at a certain value. In other words, even if an amount of heat generation of the driving control IC 82 is increased, a cooling efficiency is increased and the temperature may be stabilized.

As described above, heat transferred from the driving control IC 82 to the inner plate 41 is subjected to air-cooling by the side cover 30 and, at the same time, cooled by the cooling unit 100. Accordingly, a high heat dissipation effect may be obtained. Thus, it is possible to prevent overheating of the driving control IC 82, to maintain a relative position of the discharge unit 90 with respect to the reference plate 60 with high accuracy, and prevent to deterioration of print quality caused by increase in viscosity of the ink.

In the inkjet head 10 according to the current embodiment, heat from the driving control IC 82 may be effectively dissipated. Accordingly, a printing speed may be improved. Also, it is possible to accurately position the discharge unit 90. In particular, in a printer that discharges ink via a plurality of inkjet heads 10, variations in the positional relationship between the inkjet heads 10 may be limited. Accordingly, it is possible to improve the printing quality. Further, since ink is introduced into the cooling unit 100 to cool the inner plate 41, there is no need to separately provide a mechanism for circulating a coolant. Thus, an apparatus configuration may be simplified.

### Second Embodiment

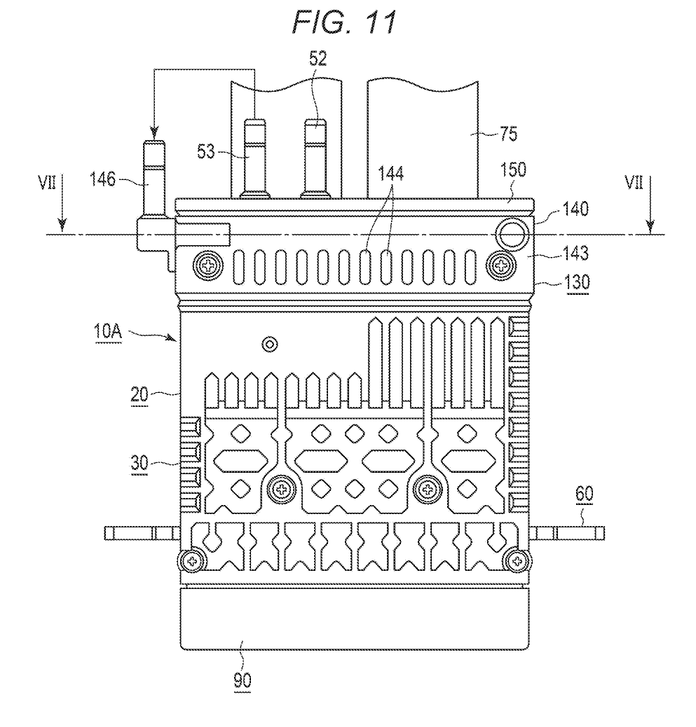

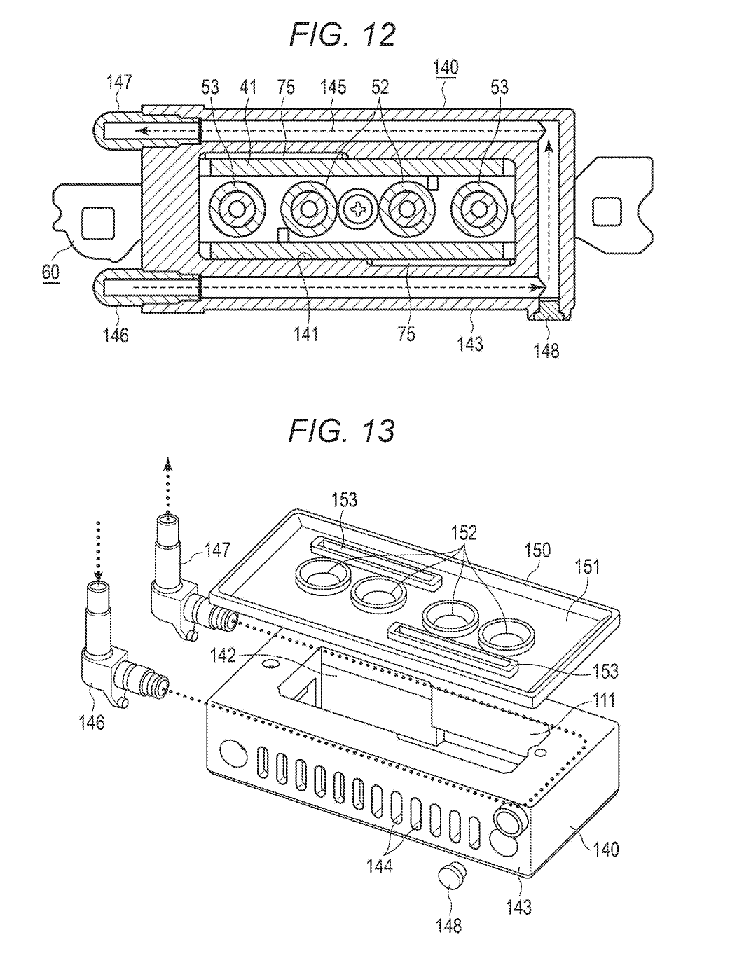

Next, an inkjet head 10A according to a second embodiment will be described with reference to FIGS. 11 to 13. FIG. 11 illustrates a front view of the inkjet head 10A. FIG. 12 illustrates a cross-sectional view of the inkjet head 10A taken along a line VII-VII of FIG. 11 and viewed in arrow direction. FIG. 13 illustrates an exploded perspective view of a cooling unit 130 in the inkjet head 10A. In the drawings, the same functional components as those in FIGS. 1 to 10 are denoted by the same reference numerals, and detailed descriptions thereof are omitted.

The cooling unit 130 includes a housing 140 having a rectangular frame shape, and a top cover 150 covering an upper surface side of the housing 140. Both the housing 140 and the top cover 150 are formed of a material having high thermal conductivity, such as aluminum, magnesium, or ceramic.

A recessed portion 142 is formed on an inner wall surface 141 of the housing 140. An upper end portion of the inner plate 41 described above is in contact with the inner wall surface 141. The flat cable 75 is positioned in the recessed portion 142. Cooling fins 144 are formed on an outer wall surface 143 of the housing 140. A flow path 145 through which ink flows is formed inside the housing 140. The flow path 145 is three long holes that do not penetrate, and a cooling ink inlet port 146 and a cooling ink outlet port 147 are formed at end portions thereof. The ink supply tube 52 is connected to the ink circulation mechanism 15. The ink discharge tube 53 is connected to the cooling ink inlet port 146. The other end of the cooling ink outlet port 147 is connected to the ink circulation mechanism 15. It is noted that a hole that is not connected with a pipe or the like is liquid-tightly closed by a plug 148. The ink supplied from the cooling ink inlet port 146 passes through the flow path 145 and is discharged from the cooling ink outlet port 147.

The top cover 150 includes a plate 151 having a plate shape. The plate 151 includes holes 152 through which two sets of ink supply tubes 52 and ink discharge tubes 53 pass. Further, a slit hole 153 through which the flat cable 75 passes is formed, and is connected to the flow path 115.

The inkjet head 10A according to the current embodiment may have the same effects as the first embodiment.

The printer 1 illustrated in FIG. 14 includes a plurality of inkjet heads 10, a head support mechanism 11 that supports the inkjet head 10 and permits movement in a direction indicated by arrows, a medium support mechanism 12 that supports the recording medium S an permits movement of the recording medium S, and a host control device 13.

As illustrated in FIG. 14, the plurality of inkjet heads 10 are arranged in parallel to each other in a certain direction and are supported by the head support mechanism 11. The host control device 13 causes a carriage 11a provided in the head support mechanism 11 to reciprocate the recording medium S in the direction indicated by the arrows in FIG. 14. The inkjet head 10 integrally includes the ink circulation mechanism 15 for recovering and supplying ink. The inkjet head 10 discharges a liquid, for example, ink, from the discharge unit 90, thereby forming a desired image on the recording medium S arranged opposite thereto.

Although the embodiments have been described above, the present disclosure is not limited by the above embodiments. For example, in the above example embodiments, the insulating film 73 is a graphite sheet, but another material may be used as long as the material has both insulating property and heat transfer property. The inkjet head 10 as described includes two sets of ink supply tubes 52 and ink discharge tubes 53, but the inkjet head 10 may instead include only one set of ink supply tube 52 and ink discharge tube 53, or may instead include three sets of ink supply tubes 52 and ink discharge tubes 53. Likewise, the ink supply tubes 52 and the ink discharge tubes 53 do not need to be paired in every embodiment. For example, the ink supply tube 52 may be a single conduit.

A printer 1 of an example embodiment is an inkjet printer that forms a two-dimensional image on the recording medium S with ink. However, the present disclosure is not limited to such embodiments. For example, a printer of the present disclosure may be a 3D printer, an industrial manufacturing machine, a medical machine, or the like. When the printer is a 3D printer, an industrial manufacturing machine, a medical machine, or the like, the printer forms a 3D object by discharging, for example, a 3D printable material or a binder for solidifying a 3D printable material from a liquid discharge head.

The printer 1 of an example embodiment includes five inkjet heads 10, and the ink colors used by each inkjet head are, respectively, cyan, magenta, yellow, black, and white. However, the number of inkjet heads 10 is not limited to five, and may be any number of one or more. Also, particular colors and characteristics of the inks used by each inkjet head 10 are not limited in any particular manner.

In some examples, the inkjet head 10 may discharge a transparent gloss ink, an ink that develops a color when irradiated by infrared rays, ultraviolet rays, or the like, or any other special ink type known in the art. The inkjet head 10 may discharge liquids other than inks. The liquid discharged by the inkjet head 10 may be dispersed liquid such as suspension or the like. Examples of liquids other than ink include a liquid containing conductive particles for forming a wiring pattern on a printed circuit board, a liquid containing cells for artificially forming a tissue, an organ, or the like, a binder, such as an adhesive, wax, a liquid resin precursor, and the like.

While certain embodiments have been described, these embodiments have been presented by way of example only, and are not intended to limit the scope of the present disclosure. Indeed, the novel embodiments described herein may be embodied in a variety of other forms; furthermore, various omissions, substitutions and changes in the form of the embodiments described herein may be made without departing from the spirit of the present disclosure. The accompanying claims and their equivalents are intended to cover such forms or modifications as would fall within the scope and spirit of the present disclosure.

What is claimed is:

1. A liquid discharge head, comprising:
a head with a plurality of discharge holes;
a liquid supply conduit through which liquid is supplied to the head;
a liquid discharge conduit through which liquid from the head flows;
a radiator including a flow path through which liquid from the liquid discharge conduit flows;
a first wiring board between the head and the radiator and having a connector connected to a wiring extending through an interior of the radiator;
a second wiring board between the head main body and the first wiring board;
a driving control element on the second wiring board and configured to control liquid discharge from the discharge holes; and
a heat conductive member extending between the head and the radiator and in thermal contact with the radiator.

2. The liquid discharge head according to claim 1, further comprising:
an elastic body urging the driving control element toward the heat conductive member.

3. The liquid discharge head according to claim 2, further comprising:
an exterior cover covering the heat conductive member, wherein
the elastic body is disposed between the driving control element and an inner surface of the exterior cover.

4. The liquid discharge head according to claim 1, wherein the liquid supply conduit and the liquid discharge conduit pass through the radiator.

5. The liquid discharge head according to claim 1, wherein the radiator includes an inlet fluid-connected to the liquid discharge conduit and an outlet from which liquid passing through the radiator is discharged.

6. The liquid discharge head according to claim 1, wherein an inlet and an outlet of the radiator extend along the liquid supply conduit and the liquid discharge conduit.

7. The liquid discharge head according to claim 1, wherein a plurality of flow paths is formed between an inlet and an outlet of the radiator.

8. The liquid discharge head according to claim 1, wherein an inlet and an outlet of the radiator are at a side surface of the radiator.

9. The liquid discharge head according to claim 1, wherein the flow path of the radiator is formed around the interior thereof.

10. The liquid discharge head according to claim 1, wherein the radiator includes a plurality of fins along at least a part of the flow path.

11. The liquid discharge head according to claim 1, further comprising:
an electrical insulating film between the heat conductive member and the first wiring board.

12. The liquid discharge head according to claim 1, wherein
the first wiring board is a non-flexible wiring board, and
the second wiring board is a flexible wiring board.

13. A liquid discharge apparatus, comprising:
a liquid discharge head including:
a head with a plurality of discharge holes;
a liquid supply conduit through which liquid is supplied to the head;
a liquid discharge conduit through which liquid from the head flows;
a radiator including a flow path through which liquid from the liquid discharge conduit flows;
a first wiring board between the head and the radiator and having a connector connected to a wiring extending through an interior of the radiator;
a second wiring board between the head main body and the first wiring board;
a driving control element on the second wiring board and configured to control liquid discharge from the discharge holes; and
a heat conductive member extending between the head and the radiator and in thermal contact with the radiator; and
a liquid circulator configured to supply liquid to the liquid supply conduit and recover liquid from the liquid discharge conduit.

14. The liquid discharge apparatus according to claim 13, wherein
the radiator includes an inlet fluid-connected to the liquid discharge conduit and an outlet from which liquid passing through the radiator is discharged, and
the liquid circulator is further configured to recover liquid from the outlet of the radiator.

15. The liquid discharge apparatus according to claim 13, wherein the liquid discharge head further includes an elastic body urging the driving control element toward the heat conductive member.

16. The liquid discharge apparatus according to claim 15, wherein
the liquid discharge head further includes an exterior cover covering the heat conductive member, and
the elastic body is disposed between an inner surface of the exterior cover and the driving control element.

17. An inkjet apparatus, comprising:
a medium holder;
a liquid discharge head including:
a head having a plurality of discharge holes;
a liquid supply conduit through which liquid is supplied to the head;
a liquid discharge conduit through which liquid from the head flows;
a radiator including a flow path through which liquid from the liquid discharge conduit flows;
a first wiring board between the head and the radiator, and having a connector connected to a wiring extending through an interior of the radiator;
a second wiring board between the head main body and the first wiring board;
a driving control element on the second wiring board and configured to control liquid discharge from the discharge holes; and
a heat conductive member extending between the head and the radiator and in thermal contact with the radiator;
a liquid circulator configured to supply liquid to the liquid supply conduit and recover liquid from the liquid discharge conduit; and
a carriage mechanism configured to move the liquid discharge head relative to the medium holder.

18. The inkjet apparatus according to claim 17, wherein
the radiator includes an inlet fluid-connected to the liquid discharge conduit and an outlet from which liquid from the radiator is discharge, and
the liquid circulator is further configured to recover liquid from the outlet of the radiator.

19. The inkjet apparatus according to claim 17, wherein the liquid discharge head further includes an elastic body urging the driving control element toward the heat conductive member.

20. The inkjet apparatus according to claim 19, wherein
the liquid discharge head further includes an exterior cover covering the heat conductive member, and
the elastic body is disposed between an inner surface of the exterior cover and the driving control element.
